(19) United States
(12) Patent Application Publication
(10) Pub. No.: US 2005/0138932 A1
(43) Pub. Date: Jun. 30, 2005

(54) Aircraft protection method and system

(76) Inventor: Nicholas V. Perricone, Madison, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 10/818,310

(22) Filed: Apr. 5, 2004

Related U.S. Application Data
(60) Provisional application No. 60/513,368, filed on Oct. 22, 2003.

(51) Int. Cl. F02C 7/00

(52) U.S. Cl. 60/772; 60/39.5

(57) ABSTRACT

In the operation of a turbojet engine of an aircraft, a method of reducing the infrared radiation in the engine's exhaust; comprising: 1) releasing infrared radiation masking material selected from the group consisting of liquid nitrogen, water, and calcined aluminum and combinations thereof into the engine's exhaust so that the infrared radiation in the exhaust is reduced.

### BACKGROUND OF THE INVENTION

1. Field of the Invention

The present invention relates to a process and system for reducing the infrared radiation in an aircraft engine's exhaust. In particular, this invention relates to a process and system for protecting that aircraft from infrared-seeking missiles.

2. Brief Description of the Art

Current security concerns throughout the world have raised concern about missile attacks on commercial jet airliners. In addition, military jet aircraft are also susceptible to attack by missiles in combat zones and hot spots.

Low cost manual shoulder-held surface-to-air missiles are available in many parts of the world and are of much concern to the safety of both commercial and military aircraft. These shoulder-fired devices use an infrared sensing device to focus in on the hot exhaust signature of an aircraft. Because of their limited range (either about 15,000 feet in altitude or about 3 miles in distance), the aircraft is mainly susceptible to attack by these missiles during take-offs and landings. Unfortunately, commercial aircraft do not have any defense against these hand-held missiles. Some military aircraft carry a defensive method such as the release of flares to basically cause the incoming missile to fly into the flares instead of the infrared heat source generated by the engines.

It is noted that U.S. Pat. No. 5,487,267 (Alquist et al.) teaches a system for suppressing infrared radiation emissions from jet engines using low molecular weight monohydric alcohols such as methyl or ethanol. It is not believed this system has been used commercially and it is still desirable to have a better system for protecting aircraft, particularly commercial airliners, from these infrared guided surface-to-air missiles. The present invention is directed to a solution to that need.

### BRIEF SUMMARY OF THE INVENTION

Therefore, one aspect of the present invention is directed to in the operation of a turbojet engine of an aircraft, a method of reducing the infrared radiation in the engine's exhaust; including:
1) releasing an infrared radiation-masking material selection from the group consisting of liquid nitrogen, water and calcined aluminum or mixtures thereof into the engine's exhaust so that the infrared radiation in the exhaust is reduced.

Another aspect of the present invention is directed to, in the operation of a turbojet engine of an aircraft, a system for reducing the infrared radiation in the engine's exhaust; including:
(a) one or more containers of the infrared radiation-masking material in said aircraft;
(b) one or more transfer lines for transferring the infrared radiation-masking material from the one or more container (a) to the posterior portion of the turbojet engine and into the engine exhaust to reduce the infrared radiation in the engine's exhaust; and
(c) controlling means for allowing the infrared radiation-masking material to flow from container (a) into lines (b).

Still another aspect of the present invention is directed to, in the operation of an aircraft having one or more turbojet engines, a method for protecting that aircraft from infrared-seeking missiles; including:
1) detecting the approach of such infrared-seeking missile toward said aircraft;
2) in immediate response to such detection, introducing infrared radiation masking material selected from the group consisting of liquid nitrogen water and calcined alumina and combinations thereof into the exhaust of each aircraft engine so that the infrared radiation in the exhaust is reduced.

Yet another aspect of the present invention is directed to, in the operation of an aircraft having one or more turbojet engines, a system for protecting that aircraft from infrared-seeking missiles; including:
(a) means for detecting the approach of said missiles toward the aircraft;
(b) one or more containers of infrared radiation-masking material selected from the group consisting of liquid nitrogen, water and calcined aluminum and combinations thereof in said aircraft;
(c) one or more transfer lines for transferring the liquid nitrogen from the one or more containers (b) to the posterior portion of each turbojet engine on the aircraft and into the engine exhaust to reduce the infrared radiation in each engine's exhaust; and
(d) controlling means for allowing the liquid nitrogen to flow from container (b) into lines (c); said controlling means coupled to detection means (a).

And still another aspect of the present invention is directed to, in the operation of an aircraft having one or more turbojet engines, a method for protecting that aircraft from infrared-seeking missiles or for lowering the sound of the aircraft's engines; comprising:
1) manually releasing an infrared radiation masking material selected from the group consisting of liquid nitrogen, water, and calcined aluminum and combinations thereof into the engine's exhaust so that either the aircraft is protected from an infrared-seeking missile or to lower the sound level of the aircraft's engines.

Furthermore, one other aspect of the present invention is directed to, in the operation of an aircraft having one or more turbojet engines; a system for protecting that aircraft from infrared-seeking missiles or for lowering the sound of the aircraft's engines; comprising:
(a) means for manually releasing an infrared radiation masking material selected from the group consisting of liquid nitrogen, water, and calcined aluminum and combinations thereof into the exhaust into one or more of the engines of the aircraft;
(b) one or more containers of the infrared radiation masking material in said aircraft;
(c) one or more transfer lines for transferring the infrared radiation masking material from the one or more containers (b) to the posterior portion of each turbojet engine on the aircraft and into the exhaust of the engine to reduce the infrared radiation in the exhaust and reduce the sound level emitted from the engines; and
(d) controlling means for allowing the infrared radiation masking material to flow from container (b) into transfer lines (c); said controlling means coupled to manual-releasing means (a).

### DETAILED DESCRIPTION OF THE INVENTION

The terms “aircraft” and “aircraft having one or more turbojet engines” as used in the present specification and claims refer to any type of aircraft (including both commercial and military aircraft) that has an engine that has an exhaust of sufficient infrared radiation to be tracked by a heat-seeking missile. While turbojet engines are a common type of engine on both commercial and military aircraft, the present invention does not exclude other types of engines that have this same characteristic.

The phrase “reducing the infrared radiation in the engine's exhaust” as used in the present specification and claims means that the total amount of infrared radiation exiting the engine as exhaust for a given time frame will be lower with this invention than without this invention. In other words, the temperature of the exhaust will be lowered by this invention and, thus, a heat-seeking missile will have more difficulty in sensing the exhaust of the engine.

The term “liquid nitrogen” refers to either the liquid state of nitrogen, generally at a temperature of approximately minus 180° C., when stored or the resulting cooled gas phase upon release.

The term “water” refers to all types of water (vapor, liquid, solid, or mixtures thereof) or aqueous solutions of other infrared radiation masking materials where the amount of water in the solution is the majority amount by weight; preferably, at least 75% by weight water; and more preferably, at least 90% by weight water. Such aqueous solutions may contain ingredients to prevent the liquid rates from freezing.

The term “calcined aluminum” refers to very small particle size (i.e. less than about 100 micron) calcined or oxidized aluminum. Any suitable calcination or oxidation technique with aluminum that forms these small particles while retaining it's infrared radiation masking properties may be employed.

In the operation of a turbojet engine, the exhaust of the turbine in such engines is a source of heat (and thus infrared radiation). The exhaust also emits heated carbonaceous materials, which also carry heat in the infrared signature. Together, the pure heat of the exhaust, these heated carbonaceous materials, and the infrared radiation emitting from the heated engine material itself create an infrared signature of the aircraft. It is this signature that heat-seeking surface-to-air (and also heat-seeking air-to-air) missiles are able to detect and target.

The present invention allows for the immediate decrease in the heat emissions in a cost effective manner. Furthermore, this invention could cool the posterior portions of the exterior portion of the turbojet engine so that that portion of the infrared signature is also reduced.

More embodiments of the present invention, liquid nitrogen may be stored in suitable containers in the wings or in appropriate places in the aircraft. It may be preferred to have one or more containers for each engine in the aircraft. Since liquid nitrogen will boil at ambient temperatures, it will be stored in such containers under positive pressure. The flow of the liquid nitrogen from these containers to the transfer lines may be regulated by means of standard valves and the like.

Alternatively, the liquid nitrogen may be produced in-situ on the aircraft. In such cases, the containers may be reaction vessels or the like where the liquid nitrogen is made.

For example, it may be desirable to have a single transfer line leading from the liquid nitrogen container to the engine. At the engine, the line may branch into several transfer lines that together terminate around the posterior portion of the cowling of the turbojet engine. They could be affixed in any manner. It may be preferable to have them all point inward toward the engine exhaust. When the valve or other flow controlling means is opened, liquid nitrogen will rush through the lines into the exhaust of the engine, thus resulting in the rapid cooling of the exhaust emissions. The aft portions of the engine cowling may also be preferably cooled, further reducing the engine's infrared signature. Even the heated particulate carbonaceous materials that may also be present in the exhaust will have their temperatures cooled, further rapidly reducing that portion of the infrared signature. Thus, heat-seeking missiles will be unable to accurately target the resulting reduced infrared signature.

It may be desirable to have a sufficient amount of liquid nitrogen in the container to automatically introduce during each takeoff or landing. Specifically, if liquid nitrogen is automatically added to the exhaust during takeoff to achieve either a distance of 3 miles from likely targeting sites or to reach an altitude of about 15,000 feet, the safety of the aircraft will be heightened. The same will be true of landings.

When a threat is detected, this system where liquid nitrogen emission into the exhaust may be either triggered manually by the pilots or automatically by threat sensors coupled to the valves or other flow control means. Also, this system may be used in combination with other defense measures, such as flares or chaf. As stated above, the system can be activated during every take-off and landing automatically as the cost of liquid nitrogen is minimal. This automatic use of this system may eliminate the need for the extra (and very expensive electronics) to detect threatening missiles.

In alternative embodiments of the present invention, water or small particle size calcined aluminum may be used instead of the liquid nitrogen in the same or similar manner as described above. Also, combinations of these materials could be used. The use of water alone or in combination with calcined aluminum particles would be even more economical than the use of liquid nitrogen. It has been observed that water reduces the thermal signature of the engine exhaust.

While protection of aircraft is the primary function of the present invention, this same method and system of reducing infrared irradiation in the exhaust may in many cases have the additional benefit of lowering the noise of the exhaust. Thus, this invention may be also employed solely for sound lowering purposes, especially on takeoffs and landings. In such an event, the pilot or other personnel on the aircraft may manually initiate the release of the liquid nitrogen into the exhaust for this purpose.

In other embodiments of the present invention, the use of these infrared radiation masking material may be used on other vehicles such as ground, amphibious and ocean-going vehicles to reduce the infrared heat signatures of such vehicles.

While the invention has been described above with reference to specific embodiments thereof, it is apparent that many changes, modifications, and variations can be made without departing from the inventive concept disclosed herein. Accordingly, it is intended to embrace all such changes, modifications and variations that fall within the spirit and broad scope of the appended claims. All patent applications, patents and other publications cited herein are incorporated by reference in their entirety.

1. In the operation of a turbojet engine of an aircraft, a method of reducing the infrared radiation in the engine's exhaust; comprising:
1) releasing infrared radiation masking material selected from the group consisting of liquid nitrogen, water, and calcined aluminum and combinations thereof into the engine's exhaust so that the infrared radiation in the exhaust is reduced.

2. The method of claim 1 wherein the infrared radiation masking material is liquid nitrogen.

3. The method of claim 1 wherein the infrared radiation masking material is water.

4. The method of claim 1 wherein the infrared radiation masking material is calcined aluminum.

5. The method of claim 1 wherein the infrared radiation masking material is a combination of at least two of liquid nitrogen, water and calcined aluminum.

6. In the operation of a turbojet engine of an aircraft, a system for reducing the infrared radiation in the engine's exhaust; comprising:
(a) one or more containers of infrared radiation masking material selected from the group consisting of liquid nitrogen, water, and calcined aluminum and combinations thereof in said aircraft;
(b) one or more transfer lines for transferring the infrared radiation masking material from the one or more container (a) to the posterior portion of the turbojet engine and into the exhaust to reduce the infrared radiation in the engine's exhaust; and
(c) controlling means for allowing the infrared radiation masking material to flow from container (a) into lines (b).

7. The system of claim 6 wherein the infrared radiation masking material is liquid nitrogen.

8. The system of claim 6 wherein the infrared radiation masking material is water.

9. The system of claim 6 wherein the infrared radiation masking material is calcined aluminum.

10. The system of claim 6 wherein the infrared radiation masking material is a combination of at least two of liquid nitrogen, water and calcined aluminum.

11. In the operation of an aircraft having one or more turbojet engines, a method for protecting that aircraft from infrared-seeking missiles; comprising:
1) detecting the approach of such infrared-seeking missile toward said aircraft;
2) in immediate response to such detection, releasing infrared radiation masking material selected from the group consisting of liquid nitrogen, water, and calcined aluminum and combinations thereof into the exhaust of each aircraft engine so that the infrared radiation in the exhaust is reduced.

12. The method of claim 11 wherein the infrared radiation masking material is liquid nitrogen.

13. The method of claim 11 wherein the infrared radiation masking material is water.

14. The method of claim 11 wherein the infrared radiation masking material is calcined aluminum.

15. The method of claim 11 wherein the infrared radiation masking material is a combination of at least two of liquid nitrogen, water and calcined aluminum.

16. In the operation of an aircraft having one or more turbojet engines, a system for protecting that aircraft from infrared-seeking missiles; comprising:
(a) means for detecting the approach of said missiles toward the aircraft;
(b) one or more containers of infrared radiation masking material selected from the group consisting of liquid nitrogen, water, and calcined aluminum and combinations thereof in said aircraft;
(c) one or more transfer lines for transferring the infrared radiation masking material selected from the group consisting of liquid nitrogen, water, and calcined aluminum and combinations thereof from the one or more containers (b) to the posterior portion of each turbojet engine on the aircraft and into the exhaust to reduce the infrared radiation in each engine's exhaust; and
(d) controlling means for allowing the infrared radiation masking material to flow from container (b) into lines (c); said controlling means coupled to detection means (a).

17. The system of claim 16 wherein the infrared radiation masking material is liquid nitrogen.

18. The system of claim 16 wherein the infrared radiation masking material is water.

19. The system of claim 16 wherein the infrared radiation masking material is calcined aluminum.

20. The system of claim 16 wherein the infrared radiation masking material is a combination of at least two of liquid nitrogen, water and calcined aluminum.

21. In the operation of an aircraft having one or more turbojet engines, a method for protecting that aircraft from infrared-seeking missiles or for lowering the sound of the aircraft's engines; comprising:
1) manually releasing infrared radiation masking material selected from the group consisting of liquid nitrogen, water, and calcined aluminum and combinations thereof into the engine's exhaust so that either the aircraft is protected from an infrared-seeking missile or to lower the sound level of the aircraft's engines.

22. The method of claim 21 wherein the infrared radiation masking material is liquid nitrogen.

23. The method of claim 21 wherein the infrared radiation masking material is water.

24. The method of claim 21 wherein the infrared radiation masking material is calcined aluminum.

25. The method of claim 21 wherein the infrared radiation masking material is a combination of at least two of liquid nitrogen, water and calcined aluminum.

26. In the operation of an aircraft having one or more turbojet engines; a system for protecting that aircraft from infrared-seeking missiles or for lowering the sound of the aircraft's engines; comprising:
(a) means for manually releasing infrared radiation masking material selected from the group consisting of liquid nitrogen, water, and calcined aluminum and combinations thereof into the exhaust into one or more of the engines of the aircraft;
(b) one or more containers of infrared radiation masking material in said aircraft;
(c) one or more transfer lines for transferring the infrared radiation masking material from the one or more containers (b) to the posterior portion of each turbojet engine on the aircraft and into the exhaust of the engine to reduce the infrared radiation in the exhaust and reduce the sound level emitted from the engines; and
(d) controlling means for allowing the infrared radiation masking material to flow from container (b) into transfer lines (c); said controlling means coupled to manual-releasing means (a).

27. The system of claim 26 wherein the infrared radiation masking material is liquid nitrogen.

28. The system of claim 26 wherein the infrared radiation masking material is water.

29. The system of claim 26 wherein the infrared radiation masking material is calcined aluminum.

30. The system of claim 26 wherein the infrared radiation masking material is a combination of at least two of liquid nitrogen, water and calcined aluminum.
